(19) United States
(12) Patent Application Publication
(10) Pub. No.: US 2024/0277455 A1
(43) Pub. Date: Aug. 22, 2024

(54) Prosthetic Scan Body Device

(71) Applicant: Samantha Dahshan, Toledo, OH (US)

(72) Inventor: Samantha Dahshan, Toledo, OH (US)

(21) Appl. No.: 18/295,402

(22) Filed: Apr. 4, 2023

Related U.S. Application Data
(60) Provisional application No. 63/447,091, filed on Feb. 21, 2023.

(51) Int. Cl. A61C 13/00; A61C 9/00

(52) U.S. Cl. CPC A61C 13/0004; A61C 9/0053; A61C 8/0001

(57) ABSTRACT

The present invention is a novel prosthetic scan body device. The device is a component that is used in digital dentistry to fabricate a well-fitting implant-supported or implant-retained prosthesis by capturing the position and the orientation of the dental implants in the dental arch from its relation to the dental prosthesis. The prosthetic scan body device is designed to be inserted into the implant related structure or component on the intaglio side of the dental prosthesis in order to transfer the implant position into an STL file and a digital model. The STL file can be imported into a computer-aided design (CAD) software, which allows for precise customization and completion of the new prototype or prosthesis design. This process will lead to improved patient outcomes and satisfaction.

### CROSS-REFERENCE TO RELATED APPLICATION

The present application claims priority to, and the benefit of, U.S. Provisional Application No. 63/447,091, which was filed on Feb. 21, 2023, and is incorporated herein by reference in its entirety.

### FIELD OF THE INVENTION

The present invention relates generally to the field of dentistry, and more particularly to the field of prosthodontics, implant, and digital dentistry. The present invention further relates to a prosthetic scan body device that provides a more accurate position of dental implants placed in the edentulous dental arch or span when used in conjunction with digital impressions of the dental prosthesis extra-orally to create a virtual implant model of the patient's mouth. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in the digital dental workflow used in the fabrication of screw-retained implant-supported prostheses/restorations or implant-retained prostheses. Generally, existing implant scan bodies that are designed to be directly screwed into dental implants intra-orally have already shown inaccuracies in capturing the position of the dental implants which in turn leads to a fabrication of inaccurate or nonpassive prosthesis/restoration that has a higher risk of mechanical failure or indirectly implant failure. The intraoral scanner gets confused while stitching all the soft tissue images between the implant scan bodies in the edentulous span or arch. Further, existing implant scan bodies also have a fixed specific length. If the dental implant is placed too deep or the soft tissue is thick, most of this implant scan body is embedded in the soft tissue sulcus, and a short part of it is exposed in the patient's mouth, which makes the scanning process very difficult. It also makes the alignment step in the design software difficult to align and verify, as a short part of implant scan body is captured. Currently a new device has been introduced into the dental field to capture a more accurate position of the dental implants in the edentulous arch. However, this device is unreasonably expensive, as it costs more than $30,000.00 US dollars.

Accordingly, a need remains for a scan body that determines an accurate position and orientation of a dental implant. The disclosed prosthetic scan body device provides an accurate position of the dental implants in the edentulous arch or span. Further, the scan body device is inserted on the intaglio surface of the screw-retained implant-supported prosthesis extra-orally to mimic the dental implant, which enables the device to be captured and scanned easier and more efficiently.

Therefore, there exists a long-felt need in the art for a prosthetic scan body device that provides users with an accurate position of dental implants in the edentulous arch or span. There is also a long-felt need in the art for a prosthetic scan body device that transfers the implant data of the well-fitting implant-supported screw-retained prosthesis from the dental arch/span to the CADCAM software. Further, there is a long-felt need in the art for a prosthetic scan body device that also includes inserting the prosthetic scan body device on the temporary cylinders, titanium bases or abutments from the intaglio surface side of the screw-retained implant-supported dental prosthesis. It can be tightened to the part of the prosthesis that usually engages into the implants directly or into the screw-retained abutments torqued on the dental implants. Moreover, there is a long-felt need in the art for a prosthetic scan body device that further includes extra-oral scanning of the prosthesis to record indirectly the implant's position in the patient's mouth. Further, there is a long-felt need in the art for a prosthetic scan body device that improves accuracy in situations when recording deep or unideal position of the dental implants for a patient. Finally, there is a long-felt need in the art for a prosthetic scan body device that saves considerable time, effort, and money for dental clinicians and lab techs, and avoids discomfort to the surrounding soft tissue of the patient as the scanning process happens extra-orally.

The subject matter disclosed and claimed herein, in one embodiment thereof, comprises a prosthetic scan body device. The device is a component that is used in digital dentistry to fabricate a well-fitting screw-retained implant-supported prosthesis or implant-retained prosthesis. The prosthetic scan body device is designed to be secured into the intaglio surface of the implant-supported or retained dental prosthesis in order to transfer the position of the implants to the digital model created during the scanning process, such that the device can derive a more accurate position of all the implants located in the edentulous arch or span. The device comprises a titanium or titanium alloy connection that is positioned inside the abutment, Ti-base, vario-base or temporary cylinder exiting from the intaglio surface side of the prosthesis (the side facing the soft tissue). The connections will be different based on the type of dental implants and would typically mimic the implant platform to record the scan at the implant level, or the connection can be similar to the screw-retained abutments (some clinicians name it multi-unit abutments) that are torqued on the dental implants which are used commonly in implant full arch treatments. In this case, it will record the implant position at the abutment level. The scan body component (i.e., the part that will be scanned) would be made of PEEK (polyetheretherketone) and can be scanned using intraoral or desktop scanners. Generally, the device can be made from the same materials used to make the implant scan body component, but different connections would be designed to fit the prosthetic connection. In other words, the connections will be designed in reverse which for the first time this will allow us to have the scanning process done extraorally. Moreover, the materials that are used to manufacturer this device can be different than what is proposed here as the dental materials keep evolving over time.

The prosthetic scan body device will be inserted on the intaglio side of the temporary cylinders, abutments, Ti-bases or in the defined area of the dental prosthesis that is designed to be inserted into the implants or on the screw-retained abutments torqued on the dental implants then, the dental prosthesis will be scanned from the gum and the teeth sides (i.e., intaglio and cameo surfaces) using either intraoral or desktop scanner. Then, an STL file is created and transferred to the CADCAM software to allow the design and fabrication of screw-retained implant supported restorations or implant-retained removable prostheses.

In this manner, the prosthetic scan body device of the present invention accomplishes all of the foregoing objectives and provides users with a device that saves considerable time, effort, and money for dental clinicians and lab techs. The device avoids discomfort to the surrounding soft tissue as the scanning process happens extra-orally. The device improves the accuracy of capturing the position of the dental implants in edentulous spans.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a prosthetic scan body device. The device is a key component that is used in digital dentistry to fabricate a well-fitting screw-retained implant-supported prosthesis or implant-retained dental prosthesis. The prosthetic scan body device is designed to be inserted into the intaglio surface of the implant-supported or implant-retained dental prosthesis in order to transfer the position and the orientation of the implants to the digital model created during the scanning process, such that the device can derive a more accurate position of all the implants located in the edentulous arch or span. The device comprises a titanium or titanium alloy connector component that is positioned inside the abutment, Ti-base, vario-base or temporary cylinder exiting from the intaglio surface side of the prosthesis (the side facing the soft tissue). The connections will be different based on the type of dental implants and would typically mimic the implant platform to record the scan at the implant level, or the connection can be similar to the screw-retained abutments (some clinicians name it multi-unit abutments) that are torqued on the dental implants and are used commonly in implant full arch treatments. In this case, it will record the implant position at the abutment level. The scan body component (i.e., the part that will be scanned) would typically be made of PEEK (polyetheretherketone) and can be scanned using intraoral or desktop scanners.

Generally, the device can be made from the same materials used to make the implant scan body component, but different connections would be designed to fit the prosthetic connection. In other words, the connections will be designed in reverse to allow for the first time the scanning process to be done extraorally. Moreover, the materials that are used to manufacturer this device can be different than what is proposed here as the dental materials keep evolving over time The prosthetic scan body device will be inserted on the defined area of the intaglio surface of the dental prosthesis that designed to be inserted on the implants or the screw-retained abutment torqued on the implant, and the dental prosthesis will be scanned from the gum and the teeth side (i.e., intaglio and cameo surfaces) to obtain a digital impressions of the implant position and generate a digital/virtual model of the dental implants. Different CADCAM dental software will need to add this device in the library of components available in the software. This device can also be added by creating a custom component within the software by in putting the dimensions and other specifications of the scan body. However, it is recommended to consult with the manufacturer and a dental CADCAM expert before attempting to create custom components to ensure accuracy and compatibility.

In one embodiment, a prosthetic scan body device is provided to be used extra-orally to determine the position and orientation of dental implants placed in the edentulous arch or span. For that purpose, the prosthetic scan body device is secured to a prosthesis which is removed from the mouth region of a patient. After that, a corresponding scan procedure is effected by means of a scan system and it will create a STL file. The detected scan result is compared to data of a reference scan body in an electronic storage library. Said comparison allows a particularly exact determination of the positioning of the dental implants in relation to the dental arch and the prosthesis. As a result, the designs of abutments and dental prostheses in the next step of the digital workflow can particularly, exactly and individually be adjusted in response to the results of the corresponding scan procedures. A sequence of other scans will be taken for the prosthesis secured on the implants inside the mouth. A scan of the soft tissue without the prosthesis and a scan of the opposing arch are obtained as additional scans. The process of acquiring those scans is desired to obtain all the information needed in designing a new prototype or a new prosthesis digitally.

In one embodiment, the dental prosthesis comprises a plurality of temporary cylinders, Ti-bases or abutments secured inside the dental prosthesis and are inserted to dental implants or screw-retained abutments torqued on implants in the dental arch using prosthetic screws. Further, the dental prosthesis comprises a platform or other suitable structure that matches the dental implants or the screw-retained abutment component torqued on the dental implant.

In one embodiment, the prosthetic scan body device comprises a scan body component attached to the defined structure of intaglio surface of the prosthesis that matches the implant or the screw-retained abutment component that is torqued on the implant; this defined structure can be a component embedded in the prosthesis such as a temporary cylinder, abutment Ti-base or vario-base or it can be made out of the prosthesis material. The scan body component may have a polygonal or a cylindrical shape, or any other suitable shape as is known in the art, and the scan body component has either a symmetrical or an asymmetrical geometry (in relation to its longitudinal central axis). The shape and/or geometry of the scan body component makes it possible (by scanning it from different directions) to determine the exact position and the orientation of the scan body component.

In one embodiment, the scan body component is a hexagonal scan body that includes chamfered edges. The hexagonal scan body has either a symmetrical or an asymmetrical geometry, permitting unambiguous determination of its position relative to the position of the neighboring scan bodies and/or dental implants, from different scanning directions.

In one embodiment, the scan body component is a cylinder with at least one groove. The cylindrical scan body has either a symmetrical or an asymmetrical geometry, permitting unambiguous determination of its position relative to the position of the neighboring scan bodies and/or dental implants, from different scanning directions.

In one embodiment, the scan body component is conical with or without a groove and has an external surface that is compatible with digital scanners used in CADCAM systems. The Conical scan body has either a symmetrical or an asymmetrical geometry, permitting unambiguous determination of its position relative to the position of the neighboring scan bodies and/or dental implants, from different scanning directions

In one embodiment, the scan body component is a quadrilateral scan body that includes chamfered edges. The quadrilateral scan body has either symmetrical or asymmetrical geometry, permitting unambiguous determination of its position relative to the position of the neighboring scan bodies and/or dental implants, from different scanning directions.

In one embodiment, the scan body component is manufactured from a plastic material, such as PEEK (polyetheretherketone), or from any other suitable radio-lucent and/or radio-transparent material as is known in the art. Generally, the prosthetic scan body device can also be made from the same material used to make the existing intra-oral scan body component, but different connections would be designed to fit the prosthetic intaglio connection (i.e., titanium or titanium alloys).

In one embodiment, the prosthetic scan body component comprises a connector component at one end which is inserted on the defined structure of intaglio surface of the prosthesis that matches the implant or the screw-retained abutment component that is torqued on the implant; this defined structure can be a component embedded in the prosthesis such as a temporary cylinder, abutment Ti-base or vario-base or it can be made out of the prosthesis material. The scan body component and the connector component are integrated in one piece. The connector component is made of metal, preferably titanium or a titanium alloy, and is configured essentially in the form of a sleeve with internal threading. Specifically, the connector component has a titanium connection that goes inside the intaglio surface of the abutment or temporary cylinder or the defined intaglio structure that has the prosthetic screw. The connector component is provided with an interface, which is molded integrally to the scan body component. The interface comprises an internal threading profile, which profiles are matched to complementary interface profiles of the corresponding prosthetic temporary cylinders, or abutments and its prosthetic screws. Specifically, the dental implant prosthesis comprises a temporary cylinder or abutment which is provided with a surface, which corresponds to the surface of the connector component, in order to allow a screwing in of the prosthetic scan body component on the temporary cylinders or abutments by using a provided screw.

The prosthetic scan body usually has a smooth surface with markings or features that aid in its accurate placement and alignment during the scanning process

The specific shape of the prosthetic scan body can vary depending on the dental implant system it is intended to be used with. Therefore, the exact shape of the prosthetic scan body can differ between different implant systems and manufacturers. However, the overall shape and design are generally standardized

The prosthetic scan body is typically attached to the dental implant prosthesis using a screw and its shape is designed to match the shape of the prosthetic intaglio connection to ensure a precise fit.

The prosthetic scan body is attached to the dental implant prosthesis possibly but uncommonly by a magnetic means while its shape is designed to match the shape of the prosthetic intaglio connection to ensure a precise fit

Dental implants have differently configured interface profiles depending, in each case, on the implant system or the implant components they are secured in. Accordingly, the connector component has interface profiles which are matched to the respective dental implant system or the screw-retained abutment components torqued on the dental implants. Whatever material the prosthesis has or is made of in the platform that fits the implant and/or the screw-retained abutment torqued on the implants. Thus, the connections of the connector component will be different based on the type of the dental implants, mimicking the implant platform or mimicking the screw-retained abutment component torqued on the implant.

In use, once the prosthetic scan body device is in position on the temporary cylinders, the defined intaglio structure that has the prosthetic screw or abutments, it is used to perform an extra-oral scanning procedure by either an intraoral scanner or a desktop scanner. During the extra-oral scanning procedure, the surface of the scan body component is scanned and a virtual scan body or a scan body surface is created by determining a plurality of data points that correspond to positions of points that are located on the surface of the physical scan body component. A digital model of dental implants in the arch will be generated in the CADCAM software.

These plurality of data points correspond to positions of points that are located on the surface of a scan body component and are compared to pre-existing stored data points, to perform the reconstruction of the position and orientation of the dental implants. Specifically, during the reconstruction phase, these data points can be used for reconstructing the position and orientation of the dental implants. It should be noted that the scanning points on the surface of the scan body component do not necessarily have to correspond to corners or edges. Any point within a surface area can be used for the above-mentioned reconstruction procedure, which simplifies the scanning procedure.

Further, the determination of the position and orientation of a dental implant or the screw-retained abutment torqued on implants comprises associating reconstructed geometrical elements with physical geometrical elements of the scan body component. For instance, reconstructed planes can be associated with physical plane areas of the surface of the scan body component. It is noted that physical corners (and also edges) are not perfect corners in a mathematical sense but are rounded. It should be understood that the reconstructed geometrical objects correspond to physical geometrical objects of a part of the scan body component that actually has been scanned.

Additionally, the extra-oral scanning is performed from the teeth and gum side (i.e., cameo and intaglio surfaces) of the prosthesis after inserting the prosthetic scan body device outside the patient's mouth. Another scan of the prosthesis inside the mouth is needed for merging and aligning in the design software. Additional scans of the soft tissue of the edentulous arch/span and the opposing arch are recommended. Then, an STL file is transferred to the design software to move forward in designing a new prototype restoration or the final prosthetic restoration. Further, in determining the position and orientation of the dental implants or screw-retained abutments torqued on implants, the device can be used to generate a digital/virtual model of the dental implants. The digital/virtual model is preferably three-dimensional so that the model can be viewed from different angles, which is useful to study the dental prosthesis.

In yet another embodiment, the prosthetic scan body device comprises a plurality of indicia.

In yet another embodiment, a method of extra-orally scanning a dental prosthesis to record the dental implant's position is disclosed. The method includes the steps of providing a prosthetic scan body device comprising a scan body with connector component attached to the defined structure of intaglio surface of the prosthesis that matches the implant or the screw-retained abutment component that is torqued on the implant; this defined structure in the prosthesis can be a component embedded in the prosthesis such as a temporary cylinder, abutment Ti-base or variobases or it can be made out of the prosthesis material. The method also comprises removing a passive and well-fitting screw-retained implant-supported prosthesis from the dental arch. Further, the method comprises inserting the scan body component on the defined structure of intaglio surface of the prosthesis that designed to be tightened on the implant or the screw-retained abutment on the implant by the prosthetic screw. Finally, the method comprises extra-orally scanning the prosthesis to record the dental implant's position.

In yet another embodiment, a prosthetic scan body can also be designed to be inserted in an implant related component embedded in the implant-retained removable prosthesis to record the implant position. Finally, the method comprises extra-orally scanning the prosthesis to record the dental implant's position.

Intraoral scanners or desktop scanners can be used to scan the prosthesis and the inserted scan body. The type of scanner and the method of scanning may vary with different technologies and the evolution of digital dentistry.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the prosthetic scan body device of the present invention showing the dental prosthesis with a plurality of temporary cylinders or abutments and the inserted prosthetic scan bodies are scanned extraorally using an intraoral scanner in accordance with the disclosed architecture;

FIG. 2 illustrates a side perspective view of one embodiment of the prosthetic scan body component of the present invention showing the reverse connection mimicking the screw-retained abutment torqued on implant in accordance with the disclosed architecture;

FIG. 3 illustrates a perspective view of one embodiment of the prosthetic scan body component of the present invention which requires removing the dental prosthesis from the patient' mouth before inserting the prosthetic scan bodies for extraoral scanning in accordance with the disclosed architecture and

FIG. 4 illustrates a flowchart showing the method of extra-orally scanning a dental prosthesis to record the dental implants position in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a prosthetic scan body device that provides users with an accurate position of dental implants in the edentulous arch or span. There is also a long-felt need in the art for a prosthetic scan body device that transfer the implants data of the passive and well-fitting implant-supported screw-retained prosthesis from the dental arch or span to the CADCAM software. Further, there is a long-felt need in the art for a prosthetic scan body device that also includes inserting the prosthetic scan body device on the temporary cylinders, Ti-bases or abutments from the intaglio surface side of the dental prosthesis. Moreover, there is a long-felt need in the art for a device that further includes extra-oral scanning of the prosthesis and the inserted prosthetic scan body device to record the implants position. Further, there is a long-felt need in the art for a prosthetic scan body device that improves accuracy in situations when recording deep or unideal position of the dental implants for a patient. Finally, there is a long-felt need in the art for a prosthetic scan body device that saves considerable time, effort, and money for dental clinicians and lab techs, and avoids discomfort to the surrounding soft tissue as the process happens extra-orally.

The present invention, in one exemplary embodiment, is a novel prosthetic scan body device. The device is a component that is used in digital dentistry to fabricate a well-fitting implant-supported or implant-retained prosthesis. The prosthetic scan body device is designed to be inserted into the implant related structure on the intaglio surface of the dental prosthesis in order to transfer the implant position or the screw-retained abutment torqued on implant position into a digital model created prior to the design process, such that the device can derive a more accurate position of all the implants located on the edentulous arch or span. The device also comprises a titanium connection that is positioned inside the intaglio area of the implant related structure within the dental prosthesis which can be but not limited to an abutment, Ti-base, vario-base or temporary cylinder. The connections will be different based on the type of dental implants and would typically mimic the implant platform if the scan is obtained at the implant-level, or the scan body connection will be similar to the screw-retained abutment that is commonly used in full arch implant treatment to obtain a scan at the abutment-level. The scan body component (i.e., the part that will be scanned) would be made of PEEK (polyetheretherketone) or any similar compatible dental material.

The present invention also includes a novel method of extra-orally scanning a dental prosthesis by using intraoral scanner or desktop scanner to record the dental implants position. The method includes the steps of providing a prosthetic scan body device comprising a scan body component attached to a temporary prosthetic component via a plurality of temporary cylinders or abutments. The method also comprises removing a passive and well-fitting implant-supported prosthesis from the dental arch. Further, the method comprises inserting the scan body component on the implant-related intaglio structure or component of the dental prosthesis such as temporary cylinders, Ti-base or abutments. Finally, the method comprises extra-orally scanning the prosthesis to record the dental implants position or the position of screw-retained abutment torqued on implant.

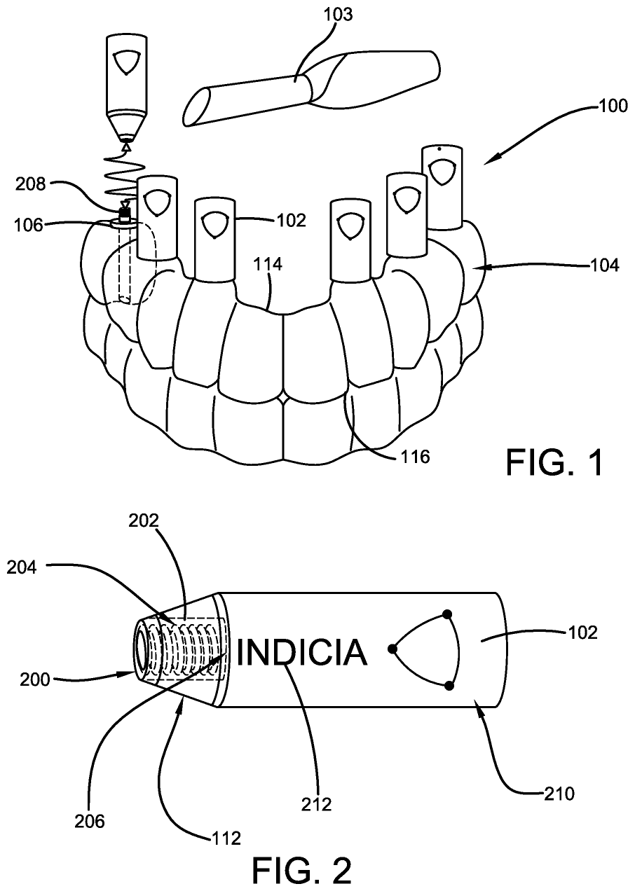

Referring initially to the drawings, FIG. 1 illustrates a perspective view of one embodiment of the prosthetic scan body device 100 of the present invention. In the present embodiment, the prosthetic scan body device 100 is a novel device 100 that provides an accurate position of dental implants in the edentulous arch 110 or span. Thus, the device 100 aids in the making and the passive fitting of prosthetic restorations. Specifically, the prosthetic scan body device 100 comprises a scan body component 102 attached to a temporary dental prosthesis 104 via a plurality of temporary cylinders, Ti-bases or abutments 106, such that the device 100 can derive the accurate position of all the dental implants 108 located on the edentulous arch 110 or the position of the screw-retained abutment 216 torqued on the dental implant 108. The device 100 also comprises a titanium connector component 112 that is positioned inside the intaglio surface 114 of the abutment, Ti-base or temporary cylinder 106. The scan body component 102 (i.e., the part that will be scanned) would typically be made of PEEK. The prosthetic scan body device 100 will be inserted on the temporary cylinders 106 of the dental prosthesis 104, and the dental prosthesis 104 will be scanned from the teeth and the gum side (i.e., cameo 116 surfaces and intaglio 114 surfaces).

Generally, the prosthetic scan body device 100 is provided to determine a positioning and orientation of dental implants 108 placed in the edentulous arch 110 by scanning extra-orally. For that purpose, the prosthetic scan body device 100 is secured to a prosthesis 104, which is removed from the mouth region of a patient. After that, a corresponding scan procedure is affected by means of a scan system 103, and STL file will be created. The detected scan result is compared to data of a reference scan body in an electronic storage library. Said comparison allows a particularly exact determination of the positioning of the dental implants 108 in relation to the dental arch 110 and the prosthesis 104. As a result, the designs of abutments 106 and dental prostheses 104 can particularly, exactly and individually be adjusted in response to the results of the corresponding scan procedures.

Specifically, the dental prosthesis 104 comprises a plurality of temporary cylinders, Ti-bases, prosthetic component of implant-related structure or abutments 106 secured within the intaglio surface 114 of the dental prosthesis 104 that will be inserted into a plurality of dental implants 108 or screw-retained abutments 216 torqued on dental implants 108 secured in a dental arch 110. For the avoidance of doubt, the reference to any of the temporary cylinders, Ti-bases, prosthetic component of implant-related structure or abutments embedded in the dental prosthesis 104 may refer to any of the same 106. Further, the dental implant 108 comprises an implant platform 118 or other suitable structure such as screw-retained abutment torqued 216 on dental implants 108. The connections of the connector component 112 will be different based on the type of the dental implants 108, mimicking the implant platform 118 or mimicking the screw-retained abutment 216 component torqued on the implant.

As shown in FIG. 2, the prosthetic scan body device 100 comprises a scan body component 102 attached to a temporary dental prosthesis 104. The scan body component 102 may have a polygonal or a cylindrical shape, or any other suitable shape as is known in the art, and the scan body component 102 has either a symmetrical or an asymmetrical geometry (in relation to its longitudinal central axis). The shape and/or geometry of the scan body component 102 makes it possible (by scanning it from different directions) to determine the exact position and the orientation of the scan body component 102.

In one embodiment, the scan body component 102 is a hexagonal scan body that includes chamfered edges. The hexagonal scan body has either a symmetrical or an asymmetrical geometry, permitting unambiguous determination of its position relative to the position of the neighboring scan bodies and/or dental implants 108, from different scanning directions.

In another embodiment, the scan body component 102 is a cylinder with at least one groove. The cylindrical scan body has either a symmetrical or an asymmetrical geometry, permitting unambiguous determination of its position relative to the position of the neighboring scan bodies and/or dental implants 108, from different scanning directions.

In one embodiment, the scan body component 102 is conical with or without a groove and has an external surface that is compatible with digital scanners used in CADCAM systems. The conical scan body has either a symmetrical or an asymmetrical geometry, permitting unambiguous determination of its position relative to the position of the neighboring scan bodies and/or dental implants 108, from different scanning directions.

In a further embodiment, the scan body component 102 is a quadrilateral scan body that includes chamfered edges. The quadrilateral scan body has either symmetrical or asymmetrical geometry, permitting unambiguous determination of its position relative to the position of the neighboring scan bodies and/or dental implants 108, from different scanning directions.

Typically, the scan body component 102 is manufactured from a plastic material, such as PEEK (polyetheretherketone), or from any other suitable radio-lucent and/or radio-transparent material as is known in the art, depending on the needs and/or wants of a user. Generally, the prosthetic scan body device 100 can be made from the same material used to make existing intraoral scan body component in the market, but different connections would be designed to fit the intaglio prosthetic connection (i.e., titanium or titanium alloys) which for the first time will allow the impression scanning to be done extraorally.

Further, the prosthetic scan body component 100 comprises a connector component 112 at one end 200 which is inserted on the intaglio side of the temporary cylinders or abutment 106 of the dental prosthesis 104. The scan body component 102 and the connector component 112 are integrated in one piece, but can be manufactured of two separate pieces and then secured together. The connector component 112 is made of metal, preferably titanium or a titanium alloy, and is configured essentially in the form of a sleeve 202 with internal threading 204. Specifically, the connector component 112 has a titanium connection that goes inside the intaglio surface 114 of the abutment or temporary cylinder 106. The connector component 112 is provided with an interface 206, which is molded integrally to the scan body component 102. The interface 206 comprises an internal threading profile 204, which profiles 204 are matched to complementary interface profiles of the corresponding dental implant's temporary cylinders or abutments 106 and its prosthetic screw 208 into which the prosthetic scan body component 100 is to be inserted onto. Specifically, the dental prosthesis 104 comprises a temporary cylinder or abutment 106 which is provided with an outer thread which most likely is its prosthetic screw 208, which corresponds to an inner thread 204 of the connector component 112, in order to allow a screwing in of the scan body component 102 on the temporary cylinders or abutments 106 by using the provided prosthetic screw 208.

Additionally, dental implants 108 have differently configured interface profiles, depending in each case on the implant system or the dental implants 108 components 216 are secured in. Accordingly, the connector component 112 has threaded interface profiles 204 which are matched to the respective dental implant system or the screw-retained abutment components 216 inserted on the dental implants 108. Whatever material the prosthesis 104 has or is comprised of in its interface is designed to accommodate the implant 108 and/or the screw-retained abutment 216 torqued on the implants 108. Thus, the connections of the connector component 112 will be different based on the type of the dental implants 108, mimicking the implant platform 118 or mimicking the screw-retained abutment component 216 torqued on the implant 108.

The prosthetic scan body component 102 is typically attached to the dental implant 108 prosthesis using a screw and its shape is designed to match the shape of the prosthetic intaglio connection to ensure a precise fit.

The prosthetic scan body component 102 is attached to the dental implant prosthesis 104 possibly but uncommonly by a magnetic means while its shape is designed to match the shape of the prosthetic intaglio connection to ensure a precise fit.

In use, once the prosthetic scan body device 100 is in position on the temporary cylinders, the defined intaglio structure or abutments 106 by using the prosthetic screw 208, it is used to perform an extra-oral scanning procedure by either an intraoral scanner 103 or a desktop scanner. During the extra-oral scanning procedure, the surface 210 of the scan body component 102 is scanned (via a scan system 103) and a virtual scan body or a scan body surface is created by determining a plurality of data points that correspond to positions of points that are located on the surface of the physical scan body component 102. A digital model of dental implants in the arch will be generated in the CADCAM software.

These plurality of data points correspond to positions of points that are located on the surface 210 of a scan body component 102 and are compared to pre-existing stored data points, to perform the reconstruction of the position and orientation of the dental implants 108 or the torqued screw-retained abutments 216 on implants 108 within the edentulous arch 110. Specifically, during the reconstruction phase, these data points can be used for reconstructing the position and orientation of the dental implants 108 or torqued screw-retained abutment 216. It should be noted that the scanning points on the surface 210 of the scan body component 102 do not necessarily have to correspond to corners or edges. Any point within a surface area can be used for the above-mentioned reconstruction procedure, which simplifies the scanning procedure.

Further, the determination of the position and orientation of a dental implant 108 comprises associating reconstructed geometrical elements with physical geometrical elements of the scan body component 102. For instance, reconstructed planes can be associated with physical plane areas of the surface 210 of the scan body component 102. It is noted that physical corners (and also edges) are not perfect corners in a mathematical sense but are rounded. It should be understood that the reconstructed geometrical objects correspond to physical geometrical objects of a part of the scan body component 102 that actually has been scanned.

Additionally, the extra-oral scanning is performed from the teeth and gum side (i.e., cameo 116 and intaglio 114 surfaces) of the prosthesis outside the patient's mouth. Then, an STL file, or other suitable file, is transferred to the design software to move forward in designing a new prototype restoration or the final prosthetic restoration. Further, in determining the position and orientation of the dental implants 108, the device 100 can be used to generate a digital/virtual model of the dental implants 108 or torqued screw-retained abutments 216 on implants 108. The digital/virtual model is preferably three-dimensional so that the model can be viewed from different angles, which is useful to study the dental prosthesis 104.

In yet another embodiment, the prosthetic scan body device 100 comprises a plurality of indicia 212. The scan body component 102 of the device 100 may include advertising, a trademark, or other letters, designs, or characters, printed, painted, stamped, or integrated into the scan body component 102, or any other indicia 212 as is known in the art. Specifically, any suitable indicia 212 as is known in the art can be included, such as, but not limited to, patterns, logos, emblems, images, symbols, designs, letters, words, characters, animals, advertisements, brands, etc., that may or may not be dental, prosthetic, or brand related.

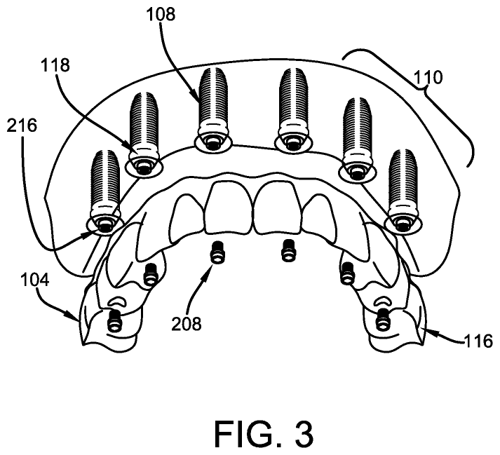

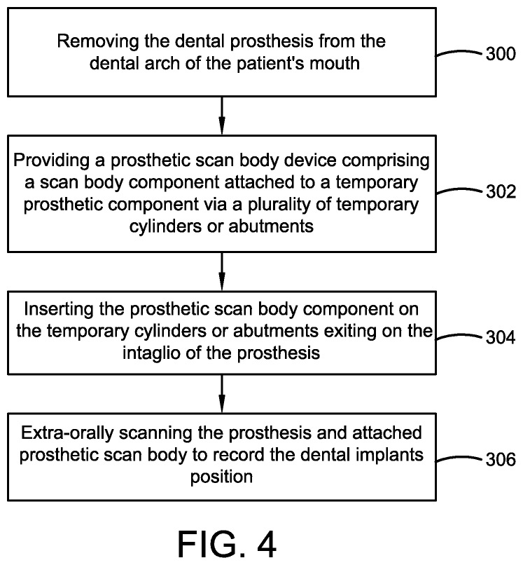

FIG. 3 illustrates a perspective view of one embodiment of the prosthetic scan body component 100 of the present invention inside of a patient's mouth in accordance with the disclosed architecture, and FIG. 4 illustrates a flowchart of the method of extra-orally scanning a dental prosthesis to record the dental implants position. The method includes the steps of at 300, removing a well-fitting implant dental prosthesis from the dental arch of the patient's mouth. The method also comprises at 302, providing a prosthetic scan body device comprising a scan body component attached to a temporary prosthetic component via a plurality of temporary cylinders or abutments. Further, the method comprises at 304, inserting the prosthetic scan body component on the temporary cylinders or abutments exiting on the intaglio side of the prosthesis. Finally, the method comprises at 306, extra-orally scanning the prosthesis and the attached prosthetic scan body to record the dental implant's position or the screw-retained abutment torqued on implants.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “prosthetic scan body device”, “prosthetic device”, and “device” are interchangeable and refer to the prosthetic scan body device 100 of the present invention.

Notwithstanding the foregoing, the prosthetic scan body device 100 of the present invention can be of any suitable size and configuration as is known in the art without affecting the overall concept of the invention, provided that it accomplishes the above-stated objectives. One of ordinary skill in the art will appreciate that the prosthetic scan body device 100 as shown in FIGS. 1-2 is for illustrative purposes only, and that many other sizes and shapes of the prosthetic scan body device 100 are well within the scope of the present disclosure. Although the dimensions of the prosthetic scan body device 100 are important design parameters for user convenience, the prosthetic scan body device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A prosthetic scan body device that provides an accurate position of dental implant placed in an edentulous arch or span by capturing it indirectly, the prosthetic scan body device comprising:
a scan body component; and
a plurality of temporary cylinders secured to the dental implants; and
wherein the plurality of temporary cylinders are securing a dental prosthesis to the dental implants;
wherein the scan body component is secured extra-orally to the plurality of temporary cylinders; and
wherein the dental prosthesis and the scan body component are scanned extra-orally using an intraoral scanner or desktop scanner to derive an accurate position of the dental implants.

2. The prosthetic scan body device of claim 1, wherein the dental prosthesis and the scan body component are scanned from both an intaglio surface and a cameo surface.

3. The prosthetic scan body device of claim 2, wherein the dental prosthesis is removed from a mouth region of a patient before attaching the scan body component and scanning extraorally.

4. The prosthetic scan body device of claim 3, wherein the dental prosthesis comprises prosthetic components that are implanted as an implant level or at an abutment level.

5. The prosthetic scan body device of claim 4, wherein the scan body component has a polygonal or a cylindrical shape.

6. The prosthetic scan body device of claim 5, wherein the scan body component is manufactured from a polyetheretherketone.

7. The prosthetic scan body device of claim 6, wherein the scan body component comprises a connector component at one end.

8. The prosthetic scan body device of claim 7, wherein the connector component is inserted on the plurality of temporary cylinders by its reverse connection.

9. The prosthetic scan body device of claim 8, wherein the connector component is made of titanium or a titanium alloy.

10. The prosthetic scan body device of claim 9, wherein the connector component has a titanium connection that is inserted on an intaglio surface of the plurality of temporary cylinders.

11. The prosthetic scan body device of claim 10, wherein the connector component comprises an interface with an internal threading profile.

12. The prosthetic scan body device of claim 11, wherein the internal threading profile matches a corresponding external threading of the prosthetic screw of a dental implant's temporary cylinder.

13. A prosthetic scan body device that provides an accurate position of dental implants in an edentulous arch or span, the prosthetic scan body device comprising:
a scan body component; and
a plurality of temporary cylinders secured to dental implants within a dental prosthesis; and
wherein the scan body component is secured to the plurality of temporary cylinders;
wherein the scan body component comprises a connector component at one end with an interface having an internal threading profile;
wherein the connector component is inserted on the plurality of temporary cylinders by a reverse connection, such that the internal threading profile matches a corresponding external threading of a dental implant's temporary cylinder;
wherein the connector component has a titanium connection that goes inside an intaglio surface of the plurality of temporary cylinders;
wherein once the prosthetic scan body device is in position on the plurality of temporary cylinders, the dental prosthesis is scanned extra-orally by an intraoral scanner or desktop scanner to derive an accurate position of the dental implants or screw-retained abutments torqued on implants; and
wherein the dental prosthesis is scanned from an intaglio surface and a cameo surface.

14. The prosthetic scan body device of claim 13 further comprising a plurality of indicia.

15. The prosthetic scan body device of claim 14, wherein during the extra-oral scanning procedure, a surface of the scan body component is scanned, and a virtual scan body component is created by determining a plurality of data points that correspond to data points on the scan body component.

16. The prosthetic scan body device of claim 15, wherein after scanning, an STL file is created and transferred to design software to create a virtual implant model to design a restoration.

17. The prosthetic scan body device of claim 13, wherein the scan body component has a polygonal or a cylindrical shape.

18. The prosthetic scan body device of claim 13, wherein the scan body component is manufactured from polyetheretherketone.

19. The prosthetic scan body device of claim 13, wherein the dental prosthesis is removed from a mouth region of a patient before scanning.

20. A method of extra-orally scanning a dental prosthesis to record the dental implant, the method comprising the following steps:
removing the temporary prosthetic component from a dental arch;
providing a prosthetic scan body device comprising a scan body component attached to a temporary prosthetic component via a plurality of temporary cylinders or abutments;
inserting the scan body component on the plurality of temporary cylinders or abutments;
extra-orally scanning the temporary prosthetic component and the scan body component to record dental implants position or screw-retained abutment torqued on implants; and
creating an STL file and transferring the STL file to a computer-aided design (CAD) software program to allow for precise customization and completion of a restoration design.
